(19) United States
(12) Patent Application Publication
(10) Pub. No.: US 2003/0010920 A1
(43) Pub. Date: Jan. 16, 2003

(54) Wide angle viewing device

(75) Inventors: Yudaya Sivathanu, West Lafayette, IN (US); Rony K. Joseph, West Lafayette, IN (US)

Correspondence Address: MICHAEL BEST & FRIEDRICH LLC, 401 NORTH MICHIGAN AVENUE, SUITE 1700, CHICAGO, IL, 60611-4212, US

(73) Assignee: Purdue Research Foundations

(21) Appl. No.: 10/241,952

(22) Filed: Sep. 12, 2002

Related U.S. Application Data
(63) Continuation of application No. 09/388,003, filed on Sep. 1, 1999.

(51) Int. Cl. G01J 5/02

(52) U.S. Cl. 250/353

(57) ABSTRACT

A wide angle viewing device comprising a viewing head, a plurality of sensors, and a detector. The sensors are connected to the viewing head with each sensor positioned facing a unique direction such that the combination of sensors effectively views and entire volume, such as an entire room. The sensors collect radiation from the volume and deliver it to the detector. In one embodiment, the viewing device is used in a flame detector for detecting the presence of a fire in the viewed volume.

### RELATED APPLICATIONS

Priority is claimed under 35 U.S.C. §120 to U.S. patent application Ser. No. 09/388,003 filed Sep. 1, 1999.

### FIELD OF THE INVENTION

The present invention relates to wide angle viewing devices. More particularly, the present invention relates to wide angle viewing devices having a plurality of sensors positioned in a predetermined arrangement for viewing an entire spherical volume for emitted radiation.

### BACKGROUND OF THE INVENTION

For many applications, it is essential to look at radiation emitted from an entire volume, such as a whole room. For example, in fire detection, it is essential to look at the entire room for fire. For monitoring combustion processes within combustors or engines, it is necessary to look at the combustion process that occurs within the entire combustor volume.

Prior art devices use fish-eye lens or other wide angle or ultra wide angle optical lens devices for viewing an entire volume. These optical lens devices must be carefully designed and constructed in order to minimize inaccuracies caused by diffraction. The surfaces of optical lens devices must be accurate to within a fraction of the wavelength of the light propagated and positioning of the lens must be accurate within the range of a few thousands of an inch. As such, prior art optical lens devices are delicate and expensive. Additionally, principles of optics and inaccuracies in optical lens devices limit the effective viewing area of optical lens devices.

Thus, there is a need for a wide angle viewing device that is durable and cost effective. There is also a need for a wide angle viewing device that is capable of viewing an entire volume, such as an entire room.

### SUMMARY OF THE INVENTION

These needs and others are satisfied by a wide angle viewing device in accordance with the present invention. A wide angle viewing device according to the present invention comprises a viewing head having a curved outer surface, a plurality of sensors and a detector connected to the sensors. The sensors are connected to the viewing head outer surface. Each sensor is positioned facing a unique direction with respect to each other sensor such that the combination of sensors effectively views an entire volume, such as an entire room.

Each sensor is configured for sensing emitted radiation coming from a unique select position, orientation, or direction in the viewed volume. The sensed emitted radiation from each of the sensors is carried to the detector where it is combined to indicate the entire emitted radiation within the volume.

Preferably, the viewing head curved outer surface includes a plurality of facets each facing a unique direction. In this embodiment, a sensor is connected to each facet.

In one embodiment, each sensor comprises a fiber-optic cable with one end connected to the viewing head curved outer surface and the other end connected to the detector. The end of each fiber-optic cable connected to the viewing head is recessed in the outer surface and configured for collecting emitted radiation from the volume. The fiber-optic cable carries the collected radiation to the detector. Preferably, the fiber-optic cables are flexible allowing the detector to be positioned at any orientation with respect to the viewing head.

A purge air system can be included for cleaning the viewing end of each fiber-optic cable. The purge air system is configured for directing purge air over the recessed end of each fiber-optic cable. In this manner, dust, dirt and other contaminants are blown away from the viewing end of each fiber-optic cable to prevent blockages.

A multi-fiber connector can be included to connect the fiber-optic cables to the detector. The multi-fiber connector has a reflective inner surface for directing all incoming radiation carried by the fiber-optic cables into the detector.

In one embodiment, the detector comprises a photo-detector equipped with a narrow band optical filter. The narrow band optical filter works to filter out unwanted radiation. For example in flame detection applications, radiation emitted by incandescent lights, sunlight, etc. can trigger false flame detection alerts. The narrow band optical filter can be configured to pass along specific wavelengths of radiation, such as near infrared radiation, which is indicative of an open flame.

In another embodiment, two near infrared photo-detectors are included. Each photo-detector is equipped with a narrow band optical filter and is configured for detecting a unique wavelength of radiation. The narrow band optical filters are configured to pass two closely-spaced, near-infrared wavelengths of radiation. Comparing the two closely-spaced, near-infrared wavelength of radiation further eliminates false flame detection alerts.

A branching device can be included so that each of the fiber-optic cables is branched to both photo-detectors. In this manner, an identical sensed emitted radiation is carried to each of the detectors.

Alternatively, the sensors can comprise fiber-optic doublets each comprising two fiber-optic cables. One end of each fiber-optic doublet is connected to the viewing head curved outer surface and the other end is connected to the detector. The end of the fiber-optic doublet connected to the viewing head outer surface collects emitted radiation from unique select positions in the volume and the fiber-optic doublets carry the collected radiation to the detector. Using fiber-optic doublets eliminates the need for a branching device in situations where an identical sensed emitted radiation is to be carried to two different detectors.

In another embodiment a spectrometer can be used as the detector for studying the emitted radiation in a volume.

In still another embodiment, the detector can comprise a plurality of detectors, each connected to a sensor. In this embodiment, the location of the radiation source can be pinpointed by determining the viewing angle of the sensor or sensors with the highest incidence of collected radiation.

A mounting plate can be included for mounting the viewing device onto a surface. The mounting plate is connected to the viewing head and includes an outer flange. Fasteners, such as screws, can be inserted through apertures in the outer flange into the mounting surface for securing the viewing device to the surface.

A high temperature withstanding transparent film can be included for protecting the viewing device. The film is placed over the viewing head thus covering the viewing head for protecting the viewing head, sensors and detector.

Additionally, a light transmitting device can be included for verifying the integrity of each sensor. The light transmitting device is configured for transmitting light into the sensors connected to the viewing head curved outer surface. The transmitted light is collected by the sensors and carried to the detector. The detector measures the collected light and compares it with the transmitted light to verify that each sensor is working properly.

In another embodiment, the viewing device is configured for carrying radiation from one area to another. The viewing device comprises a viewing head positioned in a first area and a plurality of fiber-optic cable bundles extending from the first area to a second area.

The viewing head includes a curved outer surface. Each of the fiber-optic cable bundles comprising a plurality of fiber-optic cables. A first end of each fiber-optic cable is connected to the viewing head curved outer surface and positioned facing a unique direction with respect to each other fiber-optic cable in the fiber-optic cable bundles. A second end of each fiber-optic cable is positioned in the second area.

In this manner, the fiber-optic cable bundles are configured for collecting emitted radiation from the first area and carrying the collected radiation from the first area to the second area. The collected radiation is emitted into the second area from the second end of the fiber-optic cables.

In one embodiment, the first area is located outside a building and the second area is located inside the building. In this embodiment, sunlight is collected from outside the building and delivered inside the building by the fiber-optic cable bundles. In this manner, sunlight can be delivered to plants inside the building.

A viewing device according to the present invention is capable of receiving radiation from at least a 180 degree steradian view angle up to approximately 720 degrees.

Various other features and advantages of the invention are set forth in the following drawings, detailed description, and claims.

### BRIEF DESCRIPTION OF THE DRAWINGS

FIG. 1 is a top perspective view of a wide angle viewing device according to the present invention;

FIG. 2 is a bottom perspective view of the wide angle viewing device of FIG. 1;

FIG. 3 is a top plan view of the wide angle viewing device of FIG. 1;

FIG. 4 is a bottom plan view of the wide angle viewing device of FIG. 1;

FIG. 5 is a cross-sectional view of the wide angle viewing device taken along line 5-5 of FIG. 4;

FIG. 6 is perspective view of an alternative embodiment of a wide angle viewing device according to the present invention;

FIG. 7 is a side view of another alternative embodiment of a wide angle viewing device according to the present invention;

FIG. 8 is a side view of still another alternative embodiment of a wide angle viewing device according to the present invention; and

FIG. 9 is a side view of still another alternative embodiment of a wide angle viewing device according to the present invention.

### DETAILED DESCRIPTION OF THE INVENTION

Before embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including” and “comprising” and variations thereof is meant to encompass the items listed thereafter and equivalents thereof as well as additional items.

In accordance with the present invention, a wide angle viewing device is described that provides distinct advantages when compared to those of the prior art. The invention can best be understood with reference to the accompanying drawing figures.

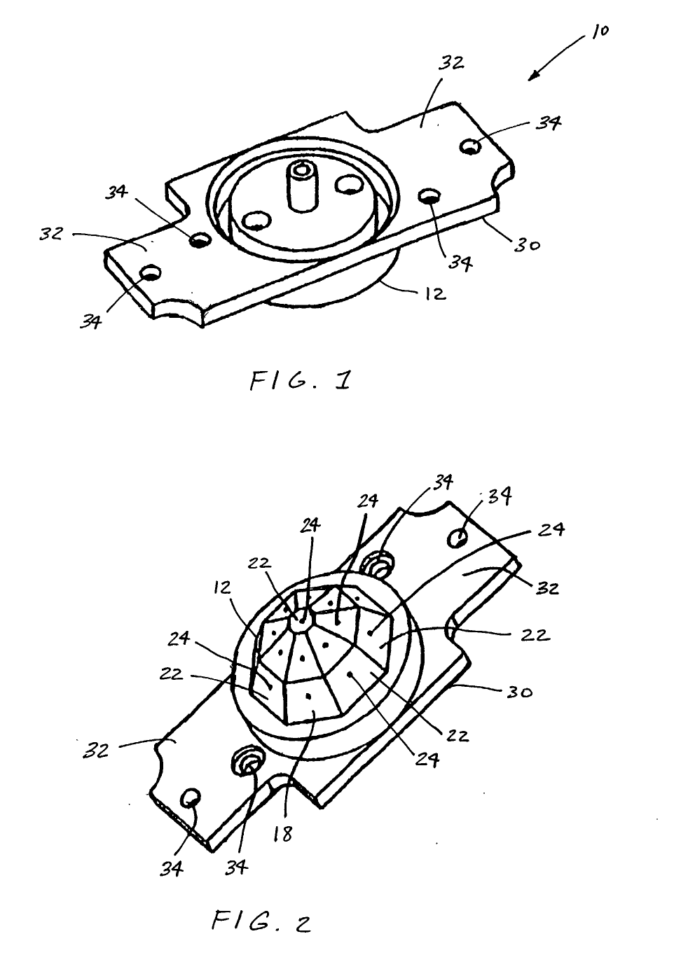

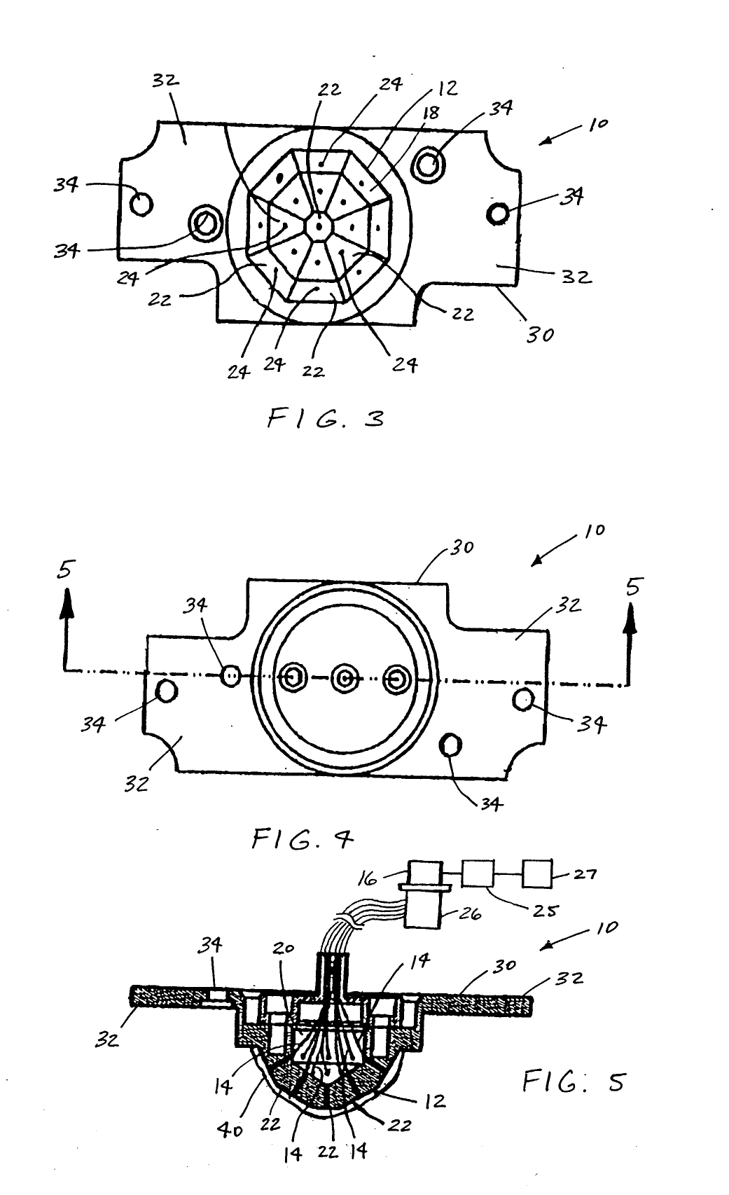

Referring now to the figures, a first embodiment of a wide angle viewing device according to the present invention is shown in FIGS. 1-5 and generally designated by reference numeral 10. The wide angle viewing device 10 comprises a viewing head 12, a plurality of sensors 14 and a detector 16. The viewing head 12 has a curved outer surface 18 and a hollow interior 20. Preferably, the outer surface 18 includes a plurality of facets 22 each facing a unique direction.

The outer surface 18 includes a plurality of apertures 24 into which the sensors 14 are arranged. The apertures 24 are located such that each sensor 14 is positioned to face in a unique direction. Each sensor 14 is responsible for viewing the portion of the volume within its viewing range. The sensors 14 are positioned such that their viewing ranges complement each other to cover the entire volume.

The sensors 14 are configured for collecting emitted radiation coming from a unique position in the volume, such as a room, and carrying the collected radiation to the detector 16. In a preferred embodiment, the sensors 14 comprise fiber-optic cables. One end of the each fiber-optic cable is positioned in one of the apertures 24 in the outer surface 18 of the viewing head 12 and the other end of each fiber-optic cable is connected to the detector 16. Preferably, the fiber-optic cables are flexible allowing the detector 16 to be positioned at any orientation with respect to the viewing head 12.

By using wide acceptance angle fiber-optic cables fewer cables are needed to view the entire volume. If narrow acceptance angle fiber-optic cables are used, the number of cables required is higher but the sensitivity of the sensors 14 is increased.

In some applications, the viewing head 10 can be configured for sensing only certain wavelengths of radiation. For example, for flame detector applications near infrared wavelengths provide the best indication of an open flame in a typical home or office and thus, the viewing head 10 is configured to sense near infrared radiation.

In one embodiment, the detector 16 comprises a photo-detector including a narrow band optical filter 25 for filtering out unwanted wavelengths of radiation. In this manner, radiation that typically triggers false flame detection alarms, such as radiation emitted by incandescent lights, sunlight, etc., can be filtered out by the narrow band optical filter. Alternatively, the detector 16 can comprise a spectrometer 27 for studying the emitted radiation in the volume.

A multi-fiber connector 26 can be included to connect the fiber-optic cables to the detector 16. The multi-fiber connector 26 has a reflective inner surface for directing all incoming radiation carried by the fiber-optic cables into the detector 16. In this manner, all radiation collected by the fiber-optic cables is presented simultaneously to the detector 16.

In another embodiment of the present invention, shown in FIG. 6, the detector 16 comprises two near infrared photo-detectors. Each photo-detector is equipped with a narrow band optical filter 25 and is configured for detecting a unique wavelength of radiation.

In this embodiment, a branching device 28 can is used for branching the fiber-optic cables to both photo-detectors. The branching device 28 splits the radiation collected by the sensors 14 into parts which are fed to each of the photo-detectors. In this manner, an identical sensed emitted radiation is carried to each of the detectors 16.

FIG. 6 also illustrates an embodiment of the present invention in which the viewing head 12 outer surface 18 comprises a smooth, semi-circular surface. In this embodiment, the sensors 14 are positioned facing in unique directions by their placement on the viewing head 12 outer surface 18.

Alternatively, as shown in the embodiment pictured in FIG. 7, the sensors 14 can comprise fiber-optic doublets each comprising two fiber-optic cables. One of the fiber-optic cables in each doublet carries the sensed emitted radiation to one of the detectors 16 in a detector pair and the other fiber-optic cable carries the sensed emitted radiation to the other detector in a detector pair 16. Using fiber-optic doublets eliminates the need for the branching device 28 of the embodiment shown in FIG. 6.

In another embodiment, shown in FIG. 8, the detector 16 can comprise a plurality of photo-detectors, with one photo-detector connected to each sensor 14. In this embodiment the exact location of the radiation source can be pinpointed by determining the viewing angle of the sensor 14 or sensors 14 with the highest incidence of collected radiation.

A mounting plate 30 can be included for mounting the viewing device 10 onto a surface. The mounting plate 30 is connected to the viewing head 12 and includes an outer flange 32 having a plurality of apertures 34. Fasteners, such as screws, nails, bolts, etc., can be inserted through the apertures 34 in the outer flange 32 and into the mounting surface for securing the viewing device 10 to the surface.

A purge air system, shown in FIG. 8, can be included for cleaning the viewing end of each fiber-optic cable. The purge air system is configured for directing purge air over the apertures 24 in the viewing head 12 outer surface 18 near the recessed end of each fiber-optic cable. The purge air system comprises compressor for generating the purge air and a plurality of air nozzles for directing the purge air over the apertures 24. In this manner, dust, dirt and other contaminants are blown away from the apertures 24 and sensors 14 to prevent blockage.

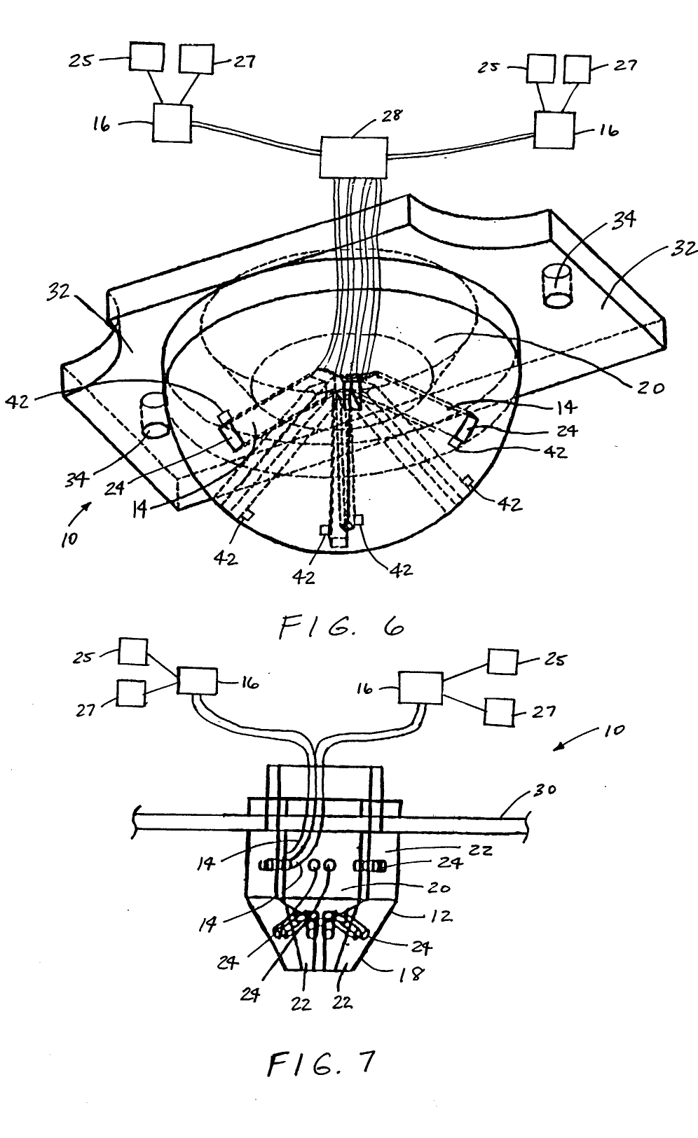

A high temperature withstanding transparent film 40 can also be included for protecting the viewing device 10. The film 40, shown in FIG. 5, is placed over the viewing head 12 thus covering the viewing head 12 outer surface 18 for protecting the viewing head 12, sensors 14 and detector 16. The film 40 prevents dust, dirt and other contaminants from entering the apertures 24 and thus clogging the sensors 14 and detector 16.

A light transmitting device 42 can also be included for verifying the integrity of each sensor 14. The light transmitting device 42, shown in FIG. 6, is configured for transmitting light into the sensors 14. The transmitted light is collected by the sensors 14 and carried to the detector 16. The detector 16 measures the collected light and compares it with the transmitted light to verify that each sensor 14 is working properly. Preferably, the light transmitting device 42 comprises a light emitting diode.

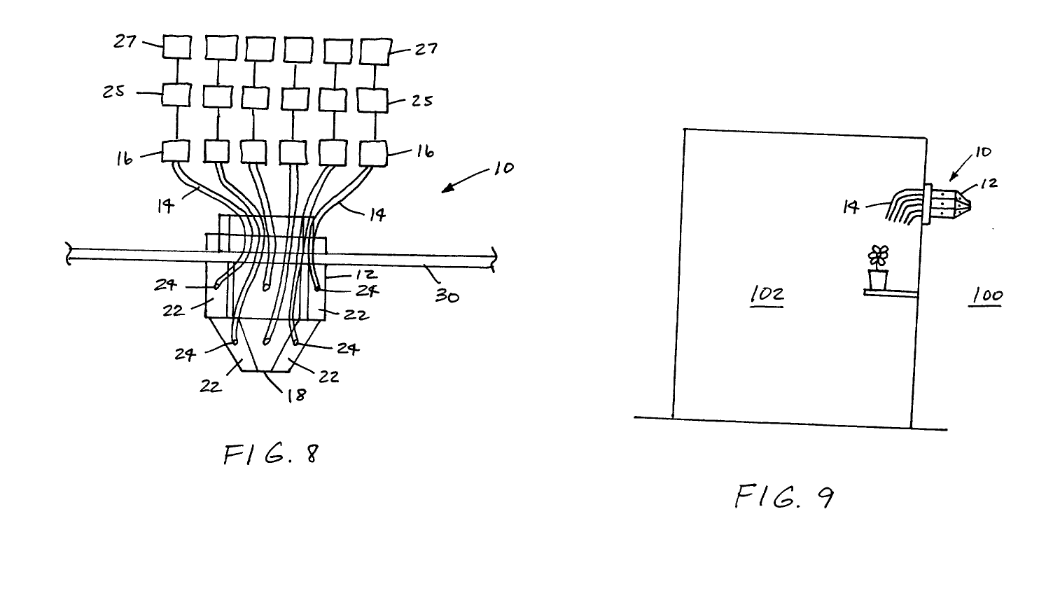

In another embodiment of the invention, shown in FIG. 9, the viewing device 10 is configured for carrying emitted radiation from a first area 100 to a second area 102. In this embodiment, the fiber-optic cables (sensors 14) are not connected to a detector 16. Instead, the end of the fiber-optic cables connected to a detector 16 in the above embodiments is positioned in the second area 102.

In this embodiment, the viewing head 12 is positioned in the first area 100 and one end of the fiber-optic cables are secured in apertures 24 in the viewing head 12. The fiber-optic cables run from the viewing head into the second area 102 with the opposite end of the fiber-optic cables in the second area 102.

In this manner, the fiber-optic cables are configured to carry emitted radiation from the first area 100 to the second area 102. The collected radiation is emitted into the second area 102 from the exposed end of the fiber-optic cables.

In one application, the viewing device 10 is used for carrying sunlight from outside a building (first area 100) to inside the building (second area 102). Thus, sunlight can be collected from outside the building and delivered to plants, etc. inside the building.

It will be apparent to those skilled in the art that modifications may be made without departing from the spirit and scope of the invention. Accordingly, it is not intended that the invention be limited except as may be necessary in view of the appended claims.

1. A wide-angle viewing device for viewing an entire volume for emitted radiation, the viewing device comprising:
a viewing head having an outer surface;
a plurality of sensors connected to the outer surface,
each one of the plurality of sensors positioned in a unique direction with respect to each other one of the plurality of sensors,
the plurality of sensors positioned to receive radiation from at least an approximately 180 degree steradian view angle, and
each one of the plurality of sensors sensing emitted radiation from a unique position such that the entire volume is viewed by the plurality of sensors; and
a detector connected to the plurality of sensors, the detector combining the emitted radiation from each one of the plurality of sensors to indicate the emitted radiation within the entire volume.

2. The viewing device of claim 1, wherein:
the viewing head includes a plurality of facets;
each one of the plurality of facets faces a unique direction; and
each one of the plurality of sensors is connected to one of the plurality of facets.

3. The viewing device of claim 1, wherein:
the outer surface of the viewing head is in a curved form; and
each one of the plurality of sensors is positioned in a unique direction with respect to the curved form.

4. The viewing device of claim 1, wherein:
the plurality of sensors includes a plurality of fiber-optic cables; and
a first end of each one of the plurality of fiber-optic cables is connected to the outer surface of the viewing head.

5. The viewing device of claim 4, wherein the fiber-optic cables are flexible allowing the detector to be positioned at any orientation with respect to the viewing head.

6. The viewing device of claim 4, further comprising:
a branching device forming a first branch and a second branch in each one of the plurality of fiber-optic cables; and
a first detector connected to the first branch and a second detector connected to the second branch.

7. The viewing device of clam 6, wherein the first detector detects a first wavelength of radiation and the second detector detects a different second wavelength of radiation.

8. The viewing device of claim 4, further comprising a multi-fiber connector connected to the plurality of fiber-optic cables and the detector.

9. The viewing device of claim 8, wherein the multi-fiber connector includes a reflective inner surface.

10. The viewing device of claim 4, further comprising a purge air system that directs air over the first end of at least one of the plurality of fiber-optic cables in order to clean at least one of the plurality of fiber-optic cables.

11. The viewing device of claim 4, further comprising a light-transmitting device that verifies the integrity of at least one of the plurality of fiber-optic cables.

12. The viewing device of claim 1, wherein the detector includes a photo-detector equipped with a narrow band optical filter.

13. The viewing device of claim 1, wherein the photo-detector includes a near infrared photo-detector.

14. The viewing device of claim 1, wherein the detector includes a spectrometer.

15. The viewing device of claim 1, wherein:
the detector is a plurality of detectors; and
each one of the plurality of detectors is connected to a sensor for detecting the location of the emitted radiation.

16. The viewing device of claim 1, wherein:
the plurality of sensors includes a plurality of fiber-optic doublets; and
a first end of each one of the plurality of fiber-optic doublets is connected to the outer surface of the viewing head.

17. The viewing device of claim 16, wherein each one of the plurality of fiber-optic doublets includes two fiber-optic cables.

18. The viewing device of claim 1, further comprising a mounting plate connected to the viewing head for mounting the viewing device onto a surface.

19. The viewing device of claim 1, further comprising a heat-resistant, transparent film covering at least a portion of the outer surface of the viewing head.

20. A wide angle viewing device for viewing an entire volume for emitted radiation, the viewing device comprising:
a viewing head having an outer surface;
a plurality of sensors connected to the outer surface,
each one of the plurality of sensors positioned in a unique direction with respect to each other one of the plurality of sensors so that the entire volume is effectively viewed by the sensors, and
the plurality of sensors positioned to receive radiation from at least an approximately 180 degree steradian view angle; and
at least one detector connected to the plurality of sensors,
the at least one detector receiving emitted radiation from the plurality of sensors, and
the at least one detector generating a signal representative of the emitted radiation for the entire volume.

21. The viewing device of claim 20, wherein:
the viewing device includes a longitudinal axis;
at least one of the plurality of sensors is positioned substantially parallel to the longitudinal axis; and
at least one other of the plurality of sensors is positioned substantially perpendicular to the longitudinal axis.

22. The viewing device of claim 20, wherein:
the viewing device includes a longitudinal axis;
at least one of the plurality of sensors is positioned within a 45 degree angle from the longitudinal axis; and
at least one other of the plurality of sensors is positioned within between a 45 degree angle and a 90 degree angle from the longitudinal axis.

23. The viewing device of claim 20, wherein:
the viewing device includes a longitudinal axis;
at least one portion of the viewed volume lies within a 45 degree angle with respect to the longitudinal axis; and
at least one other portion of the viewed volume lies between a 45 degree angle and a 90 degree angle with respect to the longitudinal axis.

24. A wide angle viewing device for viewing an entire volume for emitted radiation, the viewing device comprising:
a viewing head having an outer surface and a longitudinal axis;
a plurality of sensors connected to the outer surface,
at least one of the plurality of sensors positioned substantially parallel to the longitudinal axis,
at least one of the plurality of sensors positioned substantially perpendicular to the longitudinal axis, and
the plurality of sensors sensing radiation such that the entire volume is effectively viewed by the sensors; and
at least one detector connected to the plurality of sensors.

25. The viewing device of claim 24, wherein:
at least one of the plurality of sensors is positioned within a 45 degree angle with respect to the longitudinal axis; and
at least one other of the plurality of sensors is positioned within between a 45 degree angle and a 90 degree angle with respect to the longitudinal axis.

26. The viewing device of claim 24, wherein:
at least one portion of the viewed volume lies within a 45 degree angle with respect to the longitudinal axis; and
at least one other portion of the viewed volume lies between a 45 degree angle and a 90 degree angle with respect to the longitudinal axis.

27. A wide angle viewing device for viewing an entire volume for emitted radiation, the viewing device comprising:
a viewing head having an outer surface and a longitudinal axis;
a plurality of sensors connected to the outer surface,
at least one of the plurality of sensors positioned within a 45 degree angle with respect to the longitudinal axis,
at least one other of the plurality of sensors positioned within between a 45 degree angle and a 90 degree angle with respect to the longitudinal axis, and
the plurality of sensors sensing radiation such that the entire volume is effectively viewed by the sensors; and
at least one detector connected to the plurality of sensors.

28. A wide angle viewing device for viewing an entire volume for emitted radiation, the viewing device comprising:
a viewing head having an outer surface and a longitudinal axis;
a plurality of sensors connected to the outer surface,
each one of the plurality of sensors positioned to sense emitted radiation from a viewing range,
a sum of the emitted radiation sensed from viewing range for each one of the plurality of sensors being a value representing the emitted radiation for the entire volume,
at least one of the plurality of sensors positioned substantially parallel to the longitudinal axis, and
at least one of the plurality of sensors positioned substantially perpendicular to the longitudinal axis; and
at least one detector connected to the plurality of sensors.

29. A wide angle viewing device for viewing a volume for emitted radiation, the viewing device comprising:
a viewing head having an outer surface;
a first sensor connected to the outer surface, the first sensor positioned at a first viewing angle with respect to a radiation source;
a second sensor connected to the outer surface, the second sensor positioned at a second viewing angle with respect to the radiation source; and
a first detector connected to the first sensor to sense the first viewing angle, and a second detector connected to the second sensor to sense the second viewing angle, the first detector and the second detector comparing the first viewing angle to the second viewing angle to determine the location of the radiation source within the volume.
